(19) United States
(12) Patent Application Publication
(10) Pub. No.: US 2003/0076852 A1
(43) Pub. Date: Apr. 24, 2003

(54) Communication apparatus capable of selectively using a plurality of access channels

(76) Inventor: Kiyoshi Fukui, Mie (JP)

Correspondence Address: VENABLE, BAETJER, HOWARD AND CIVILETTI, LLP, P.O. BOX 34385, WASHINGTON, DC, 20043-9998, US

(21) Appl. No.: 10/274,206

(22) Filed: Oct. 21, 2002

(30) Foreign Application Priority Data
Oct. 23, 2001 (JP) 2001-325124

(51) Int. Cl. H04L 12/28

(52) U.S. Cl. 370/431

(57) ABSTRACT

A communication apparatus is connected to a network on one of a plurality of access channels selected. An amount detecting circuit detects the amount having influence on the quality of communication held on the access channel selected. A selecting circuit selects one of the access channels to be used for communication in accordance with the amount detected by the amount detecting circuit. The communication apparatus dynamically selects an optimum access channel for thereby effecting efficient, high-quality communication.

### BACKGROUND OF THE INVENTION

1. Field of the Invention

The present invention relates to a communication apparatus and more particularly to a communication apparatus including interfaces for selectively using a plurality of access channels and capable of switching an access channel in use during communication.

2. Description of the Background Art

Generally, when a communication apparatus in movement is to be connected to a particular network on an access channel or line in order to communicate with another communication apparatus also connected to the network, the user of the communication apparatus selects an access channel optimum for the communication and then connects the apparatus to the network on the selected channel. However, the most optimum access channel to be selected may dynamically change as the communication apparatus moves while communicating, so that the access channel selected may not always be continuously optimum during the communication.

In light of the above, Japanese patent laid-open publication No. 2000-194633, for example, discloses an access system in which a communication apparatus is configured to automatically select an optimum access point in dependent upon where it is and switch its access channel on detecting when there appears a more optimum access point. More specifically, in the disclosed access system, the communication apparatus stores a table listing the position information of the apparatus in a network and the closer, i.e. more inexpensive access points of the network in one-to-one correspondence and can therefore see an access point closest to the apparatus by referencing the table. Every time the communication apparatus detects when there appears a closer access point than before, it switches to the closer access point to continue communication without interruption to thereby save toll charges.

However, in the prior art access system described above, the communication apparatus includes only its single access channel and simply switches, when it detects a closer access point while it moves, to the closer access point to which the access channel should be connected. That means that the communication apparatus is not adapted to select another access channel itself.

The quality of communication held in an access channel is likely to vary in dependence upon the instantaneous property of the access channel itself. In light of this, a communication apparatus may be provided with a plurality of access channels available and select one of them to use for communication, as needed. However, a communication apparatus including a plurality of access channels to be selectively used and a plurality of access channel interfaces brings about other various problems, as will be described hereinafter.

Generally, there are access channels which are available to communication apparatuses moving at high speed or only to those moving at low speed, particular to a communication scheme involved. Therefore, in a communication apparatus including, e.g. two access channel interfaces respectively assigned to high-speed movement and low-speed movement, the optimum access channel to be selected may sometimes be different in dependent on the moving speed of the apparatus even when the apparatus is at the same position instantaneously.

Further, when a plurality of communication apparatuses share a single access channel, the frequency band available for each of the apparatuses depends upon the number of apparatuses sharing the single access channel and the amount of data output from or input to the individual apparatus. In addition, the error characteristic of the individual access channel is likely to be affected by, e.g. the interference from the signals radiated from other communication apparatuses, depending on the radio communication scheme assigned to the access channel. When the frequency band or the error characteristic varies, as stated above, it is impossible to determine an optimum access channel when only the position information of the communication apparatus is relied on as in the prior art access system described previously.

Consequently, the conventional system configured to select an access channel in dependence upon the position of the communication apparatus cannot detect the replacement of an optimum access channel, resulting in low communication efficiency.

Moreover, if the access channel is switched while a great amount of data are being transmitted or received, data transmission is interrupted by the switching operation, aggravating the delay of data transmission or the loss of data. With the measured-rate type of charging system, switching the access channel just after the start of a unit chargeable time is not benefit for the user from the cost standpoint. In the case of automatic access channel switching, the switching operation may. frequently be repeated and therefore disadvantageous when cumulated.

### SUMMARY OF THE INVENTION

It is an object of the present invention to provide a communication apparatus capable of effecting efficient, high-quality communication by using a plurality of access channels.

In accordance with the present invention, a communication apparatus is connected to a network on one of a plurality of access channels selected. An amount detecting circuit detects an amount or parameter having influence on the quality of communication held on the access channel selected. A selecting circuit selects one of the access channels to be used for communication in accordance with the amount detected by the amount detecting circuit.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a communication apparatus embodying the present invention;

FIG. 2 is a schematic block diagram showing a specific configuration of a speed detecting circuit included in the illustrative embodiment;

FIG. 3 is a schematic block diagram showing an alternative embodiment of the present invention;

FIG. 4 is a schematic block diagram showing another alternative embodiment of the present invention;

FIG. 5 is a schematic block diagram showing a further alternative embodiment of the present invention;

FIG. 6 shows the general configuration of a specific communication system to which the illustrative embodiments are applicable; and

FIG. 7 shows a specific table included in the embodiment shown in FIG. 1.

### DESCRIPTION OF THE PREFERRED EMBODIMENTS

Preferred embodiments of the communication apparatus in accordance with the present invention will be described hereinafter.

The word “access channel” or “connect channel” refers to a channel connecting a network owned by a communication service company to the user expected to use the network and is generally either one of a wired channel and a radio channel. Some of the illustrative embodiments to be described are basically applicable only to radio access channels in nature while the other embodiments are applicable to both of radio access channels and wired access channels.

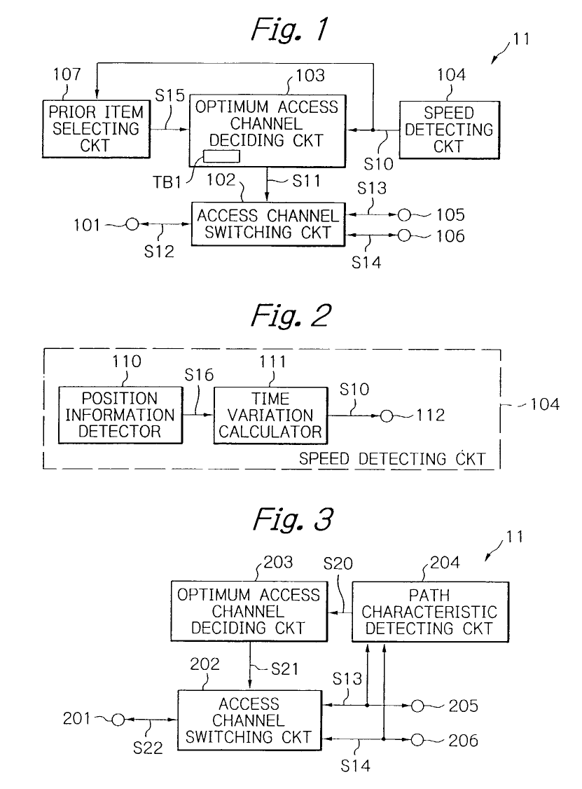

An embodiment to be described with reference to FIGS. 1 and 2 is basically assumed to use radio access channels because communication apparatuses are assumed to be mobile. In this case, therefore, the user's communication apparatus may be a portable telephone while the communication service company may be a mobile telephone service company.

Usually, an access channel is accompanied by a physical substance and consumes physical resources. Communication charges therefore generally tend to depend upon the consumption of the physical resources. The physical resources may include a frequency resource or a time resource in a common frequency band.

Embodiments to be described with reference to FIGS. 1 through 4 are identical in that they include a plurality of access channel interfaces, determine an optimum access channel while in communication, and dynamically or adaptively switches, upon detecting a more optimum access channel than before, the access channel to be used for communication to such a new optimum access channel.

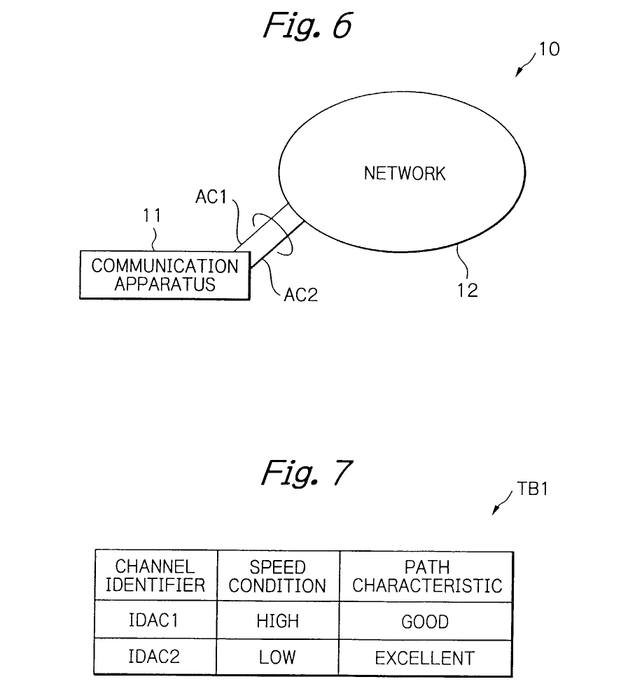

FIG. 6 of the drawings shows a specific communication system to which applicable are preferred embodiments of the communication apparatus in accordance with the present invention. As shown, the communication system, generally 10, includes a communication apparatus 11 and a network 12. While the communication apparatus 11 is mobile, it may be implemented as any one of modern communication apparatuses including a PDA (Personal Digital Assistant), a pager terminal, a PHS (Personal Handyphone System) terminal, an electronic mail (email) terminal, and a cellular phone.

In an application in which the communication apparatus 11 is a cellular phone, the network 12 is a cellular phone network and allows the communication apparatus 11 to communicate with a base station, not shown, included in the network 12 by radio. For radio communication, the communication apparatus 11 and the base station are interconnected to each other by either one of access channels AC1 and AC2. While three or more access channels for communication may, of course, be arranged between the communication apparatus 11 and the network 12, two access channels AC1 and AC2 are selectively used in this specific communication system.

When other communication apparatuses are expected to communicate with the base station of the network 12 on a single access channel in addition to the communication apparatus 11, a multiplex communication system (shared use mentioned earlier) is necessary. The access channel consumes a time resource when the multiplex communication system is implemented as a TDMA (Time Division Multiple Access) system or consumes a frequency resource when it is implemented as an FDMA (Frequency Division Multiple Access) system. By contrast, in a CDMA (Code Division Multiple Access) system that is another possible multiplex communication system, the access channel consumes mere logical codes. However, even with the CDMA system, the access channel may be considered to consume a physical resource because the number of frequencies to be multiplexed on the same frequency band is limited due to the influence of interference.

Reference will be made to FIG. 1 for describing a preferred embodiment of the present invention. As shown, the communication apparatus 11 includes an input/output terminal 101, an access channel switching circuit 102, an optimum access channel deciding circuit 103, a speed detecting circuit 104, a prior item selecting circuit 107, a channel 1 interface 105, and a channel 2 interface 106. The speed detecting circuit 104 is configured to detect the moving speed of the communication apparatus 11. While various different methods are available for the communication apparatus 11 in travel to detect its moving speed, the speed detecting circuit 104 detects the moving speed with a specific configuration shown in FIG. 2.

As shown in FIG. 2, the speed detecting circuit 104 is made up of a position information detector 110 and a time variation calculator 111. The position information detector 110 obtains position information S16 representative of the position of the communication apparatus 11 on the basis of, e.g. a signal delivered from GPS (Global Positioning System). The time variation calculator 111 calculates a variation of the position information S16 per unit time to thereby output speed information S10 representative of the moving speed of the communication apparatus 11.

The optimum access channel deciding circuit 103 determines, basically based on the speed information S10 output from the speed detecting circuit 104, which of the access channels AC1 and AC2 available for the communication apparatus 11 is optimum. The deciding circuit 103 outputs channel designation information S11 representative of the result of decision. For this purpose, the deciding circuit 103 should preferably store a table TB1 listing a relation between the access channels AC1 and AC2 and the moving speeds adequate for the access channels AC1 and AC2.

FIG. 7 shows a specific format of the table TB1 listing the relation mentioned above. As shown, the table TB1 includes data items “channel identifier”, “speed condition”, and “path characteristic”. The channel identifier distinguishes the access channels AC1 and AC2 by assigning IDAC1 and IDAC2 to the access channels AC1 and AC2, respectively. The speed condition shows high-speed movement or low-speed movement for which the access channels AC1 and AC2 each are suitable; the words “high” and “low” indicate high-speed movement and low-speed movement, respectively. The path characteristic shows the path characteristic of each of the access channels AC1 and AC2; the words “good” and “excellent” indicate that the path condition is good and excellent, respectively.

The path characteristic dynamically varies in dependence upon the surrounding electromagnetic wave environment and the number of frequencies multiplexed for multiplex communication and should therefore be updated in accordance with the variation of such factors. The speed condition may also be dynamically updated, as needed. It is to be noted that the path characteristic may be replaced with any other suitable item except for the speed condition.

Referring again to FIG. 1, the prior item selecting circuit 107 selects, when searching the channel identifiers IDAC1 and IDAC2, one of the data items to be referenced with priority in accordance with the speed information S10 output from the speed detecting circuit 104. The selecting circuit 107 outputs priority item information S15 indicative of the speed condition or the path characteristic to be referenced with priority. Therefore, when the communication apparatus 11 is moving at higher speed, the prior item information S15 designates the access channel feasible for communication to be held during movement, i.e., the access channel AC1 in the illustrative embodiment. On the other hand, when the communication apparatus 11 is moving at lower speed or stand still, the information S15 designates either one of the access channel AC1 and AC2 on the basis of a condition other than the moving speed, i.e., the path characteristic in the illustrative embodiment.

More specifically, the high-speed movement of the communication apparatus 11 is usually not desirable in the communication quality aspect; the moving speed influences communication quality more than the other conditions. When the communication apparatus 11 is moving at lower speed or in a stop, the conditions other than the moving speed, e.g. the path characteristic influences communication quality more than the moving speed. In this sense, the configuration of the prior item selecting circuit 107 described above enhances the possibility of high communication quality.

The prior item information S15 and speed information S10 output from the prior item selecting circuit 107 and speed detecting circuit 104, respectively, are input to the optimum access channel deciding circuit 103. The table TB1 shown in FIG. 7 lists only two sets of data. The optimum access channel deciding circuit 103 therefore classifies the speed information S10 into either one of high speed and low speed by using, e.g. a preselected threshold value.

When the speed information S10 is representative of high speed, the prior item information S15 gives priority to the speed condition as a data item while neglecting the path characteristic. The access channel AC1 or AC2 is therefore selected in accordance with the moving speed. In this case, because the communication apparatus 11 is moving at higher speed, the optimum access channel deciding circuit 103 selects the channel identifier IDAC1 belonging to the upper data set shown in FIG. 7.

When the speed information is representative of low speed, which includes a stop, the prior item information gives priority to the path characteristics while neglecting the speed condition. The access channel AC1 or AC2 is therefore selected in accordance with the path characteristic. More specifically, the path characteristic is “excellent” in the lower data set and “good” in the upper data set in the specific condition shown in FIG. 7, so that the optimum access channel deciding circuit 103 selects the channel identifier IDAC2 corresponding to the lower data set.

The channel designation information S11 output from the optimum access channel deciding circuit 103 is input to the access channel switching circuit 102. In response, the switching circuit 102 replaces, if necessary, the access channel to be used for communication. Further, the switching circuit 102 has a channel control function for outputting a channel connect request or a channel disconnect request, as needed.

More specifically, assume that the channel designation information S11 designates the access channel AC1 by way of example. Then, the access channel switching circuit 102 determines whether or not the access channel AC1 is connected to the network 12. If the access channel AC1 is connected to the network 12, then the switching circuit 102 transfers data to be sent to the channel interface 105 assigned to the access channel AC1. If the access channel AC1 is not connected to the network 12, then the switching circuit 102 executes processing for connecting the former to the latter and then transfers the above data to the channel interface 105. The switching circuit 102 executes a similar procedure when the channel designation information S11 designates the other access channel AC2.

The optimum access channel deciding circuit 103 may operate in a particular manner in each of different communication modes to be effected by the communication apparatus 11 on, e.g. the access channel AC1. For example, when the communication apparatus 11 deals with telephonic conversation that attaches importance to real-time processing, among others, it is important to maintain continuous communication at the sacrifice of communication quality. On the other hand, importance is attached to communication quality more than to real-time processing when the communication apparatus 11 deals with Java (trademark) or similar program codes (intermediate codes), which must be free from even a one-bit error. Resend control available with, e.g. the transport layer of an OSI (Open Systems Interconnection) reference model can make up for the fall of physical transmission quality of the access channel to a certain degree. However, even resend control is difficult to execute if the physical transmission quality of the access channel is low. Moreover, resend control naturally lowers communication efficiency.

In the above circumstances, it is likely that the optimum access channel deciding circuit 103 must selectively operate in the following manner. When importance is attached to real-time processing, the deciding circuit 103 immediately selects either one of the access channels AC1 and AC2. When importance is attached to high communication quality, but it is not achievable with either one of the access channels AC1 and AC2, the deciding circuit 103 simply waits for the improvement of the communication environment without selecting the access channel AC1 or AC2.

During up-going communication directed from the communication apparatus 11 toward the network 12, user data S12 are input to the apparatus 11 via the input/output terminal 101. The access channel switching circuit 102 routs the user data S12 to either one of the channel 1 interface 105 and channel 2 interface 106 assigned to the access channels AC1 and AC2, respectively. The channel 1 interface 105 and channel 2 interface 106 each may include a modulator, an encoder, and a high-frequency circuit, not shown.

During down-going communication directed from the network 12 to the communication apparatus 11, signals are routed through the communication apparatus 11 in the direction opposite to the direction stated above. While whether or not a single access channel is shared by up-going communication and down-going communication depends on the communication system, the following description will concentrate on bidirectional communication sharing a single access channel by way of example.

A specific operation of the illustrative embodiment will be described hereinafter. First, when the communication apparatus 11 is in a stop or moving at lower speed and transmits and receives data requiring real-time processing to and from the network 12, as stated earlier, the access channel to be used is determined by the optimum access channel deciding circuit 103 in accordance with the path characteristic. Therefore, assuming the current data sets shown in Table 7, then the access channel AC2 whose path characteristic is “excellent” is selected. On the other hand, if the upper data of FIG. 7 is “excellent”, then the access channel AC1 is selected.

Further, which of the access channels AC1 and AC2 should be selected when the path characteristic data in both of the upper and lower data sets are “excellent” or “good” may be determined beforehand. In addition, the table TB1 shown in FIG. 7 may include an additional data item for the selection, e.g. one listing communication charges, in which case the access channel lower in communication charge will be selected.

The speed detecting circuit 104 continuously monitors the moving speed of the communication apparatus 11 throughout the communication. When the moving speed represented by the speed information S10 output from the speed detecting circuit 104 changes from lower to higher speed, the prior item selecting circuit 107 outputs prior item information S15 that causes priority to be given to the speed condition as a data item. In response to the prior item information S15, the optimum access channel deciding circuit 103 outputs, by referencing the table TB1, channel designation information S11 designating the access channel AC1 that matches with high-speed movement.

On receiving the channel designation information S18, the access channel switching circuit 102, which has selected the access channel AC2, sees that the access channel should be switched. The switching circuit 102, which has the previously stated channel control function, connects the access channel AC1 to the network 12 while disconnecting the access channel AC2 from the network 12. Thereafter, the access channel will be repeatedly switched in the same manner in response to a change in the moving speed of the communication apparatus or a change in path characteristic.

As stated above, the illustrative embodiment replaces the data item given priority responsively to the moving speed of the communication apparatus 11. This successfully promotes the efficient use of a limited number of access channels for thereby enhancing high communication quality.

Referring to FIG. 3, an alternative embodiment of the present invention will be described. The following description will concentrate on differences between this embodiment and the previous embodiment. Briefly, the illustrative embodiment provides a preferable method of measuring the path characteristic, which is not shown nor described specifically in relation to the previous embodiment. The illustrative embodiment is assumed to use radio access channels although it is practicable with wired access channels as well.

As shown in FIG. 3, the communication apparatus 11 does not include a circuit corresponding to the prior item selecting circuit 107, FIG. 1. More specifically, the communication apparatus 11 includes an input/output terminal 201, an access channel switching circuit 202, an optimum access channel deciding circuit 203, a path characteristic detecting circuit 204, a channel 1 interface 205, and a channel 2 interface 206. The input/output terminal 201, access channel switching circuit 202, channel 1 interface 205 and channel 2 interface 206 may be respectively identical in function with the corresponding components 101, 102, 105 and 106 shown in FIG. 1.

The optimum access channel deciding circuit 203 is similar in function with the optimum access channel deciding circuit 103, FIG. 1, except for the following. While the deciding circuit 103 of the previous embodiment cooperates with the prior item selecting circuit 107, the deciding circuit 203 of the illustrative embodiment simply selects the optimum access channel in accordance with path characteristic information S20 output from the path characteristic detecting circuit 204.

The path characteristic detecting circuit 204 is connected to the optimum access channel deciding circuit 203 for detecting preselected path characteristics via the channel 1 interface 205 and channel 2 interface 206. The preselected path characteristic may be any one of the frequency of a data error or a data loss, transmission delay, and the fluctuation of transmission delay.

To measure the transmission characteristic, the path characteristic detecting circuit 204 may cause the individual access channel to operate with an application. In such a case, the individual access channel sends out a request frame, e.g. a UNIX (trade name) ping (Packet InterNet Grouper) command to the base station, a remote communication terminal connected to the base station or similar destination and receives a response frame returned from the destination. The detecting circuit 204 compares the content of the request frame with that of the response frame and then confirms, based on the result of comparison, the connection of the path and physical transmission delay. Further, by repeating the comparison a plurality of times, the detecting circuit 204 can measure the fluctuation of transmission delay or the degree of stability of the access channel as well. A function similar to the ping command is installed not only in UNIX machines but also in other most machines capable of handling TCP/IP (Transmission Control Protocol/Internet Protocol).

When the path characteristic to be measured is, e.g. a data error rate, the interchange of the request frame and response frame mentioned above is not necessary because processing originally executed by the channel 1 interface 205 or the channel 2 interface 206 for communication (effected via the input/output terminal 201) can be used. In an exemplary application where the channel interface 205 or 206 is configured to monitor BER (Bit Error Rate) for controlling transmission power between the communication apparatus 11 and the base station, BER measured by the channel interface 205 or 206 or transmission power control data transmitted from the base station to the communication apparatus 11 on the basis of BER measured by the base station can be used as an index.

In the illustrative embodiment, the optimum access channel deciding circuit 203 feeds the access channel switching circuit 202 with channel designation information S21 for causing the switching circuit 202 to select the access channel AC1 or AC2 whose path characteristic is currently desirable. In response, the switching circuit 202 switches the access channel in use, as needed. Therefore, if the access channel not used, e.g. the access channel AC1 is superior in path characteristic to the access channel AC2 in use, then the former can be replaced with the latter. If the access channel AC1 not used is inferior in path characteristic to the access channel AC2 in use, then the access channel AC2 can be maintained active. In this manner, the illustrative embodiment maintains high-quality communication by using the access channel whose path characteristic is desirable.

As for estimation, it is assumed that the lower the frequency of, e.g. data error or loss or the smaller the transmission delay or the fluctuation of transmission delay is, the more desirable the path characteristic is.

As stated above, the illustrative embodiment insures high communication quality by selecting one of the access channels more desirable in path characteristic than the other access channel.

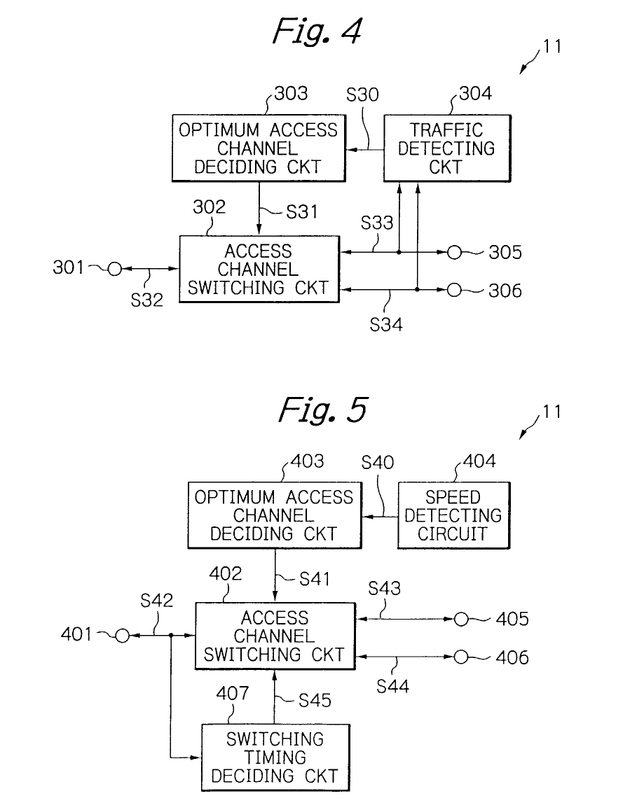

Another alternative embodiment of the present invention will be described with reference to FIG. 4. This embodiment is similar to the embodiment of FIG. 3 except for the following. Briefly, the illustrative embodiment selects one of the access channels AC1 and AC2 by measuring the traffic of the individual access channel in place of the path characteristic described with reference to FIG. 3. The illustrative embodiment is also assumed to use radio access channels although it is practicable with wired access channels as well.

As shown in FIG. 4, the communication apparatus 11 includes an input/output terminal 301, an access channel switching circuit 302, an optimum access channel deciding circuit 303, a traffic detecting circuit 304, a channel 1 interface 305, and a channel 2 interface 306. The input/output terminal 301, access channel switching circuit 302, channel 1 interface 305 and channel 2 interface 306 may be respectively identical in function with the corresponding circuit components 201, 202, 205 and 206 shown in FIG. 3. The optimum access channel deciding circuit 303 differs from the optimum access channel deciding circuit 203, FIG. 3, in that it designates the optimum access channel in accordance with traffic information S30 in place of the path characteristic information S20.

More specifically, the traffic detecting circuit 304 measures the traffic of the individual access channel and feeds the optimum access channel deciding circuit 303 with traffic information S30 representative of the result of measurement. It is to be noted that as a rule the traffic to be measured relates to communications other than the communication handled by the communication apparatus 11 per se. However, it may include both. In this sense, the illustrative embodiment is adapted to effect multiplex communication described in relation to the embodiment of FIG. 1. In this connection, in the embodiment shown in FIG. 3, while the path characteristic is susceptible to the number of frequencies multiplexed on each access channel, it is susceptible to factors other than multiplex communication as well, e.g. noise ascribable to the environment. This distinguishes the illustrative embodiment from the embodiment of FIG. 3.

In the case of multiplex communication allowing a plurality of communication apparatuses to share a single access channel, the traffic of the access channel is the amount of data being output and input to all of the communication apparatus, which include the communication apparatus 11. However, in the communication apparatus 11, the traffic detecting circuit 304 can measure, via the channel interface 305 or 306, data being output and input to the other communication apparatuses sharing the same access channel with the apparatus 11.

Generally, lighter traffic on a given access channel is more desirable for communication in the aspect of frequency band and communication quality. In light of this, the optimum access channel deciding circuit 303 compares the channel-by-channel traffic represented by the traffic information S30 output from the traffic detecting circuit 304. The deciding circuit 303 then outputs channel designation information S31 representative of one access channel lighter in traffic than the other access channel. The access channel switching circuit 302 switches the access channel in use, as needed, based on the channel designation information S31.

As stated above, the illustrative embodiment switches the access channel in use on the basis of the traffic of the individual access channel and can therefore insure high communication quality by selecting an access channel having a margin as to communication band.

Reference will be made to FIG. 5 for describing a further embodiment of the present invention. This embodiment is essentially similar to the embodiment of FIG. 1 except for the following. Briefly, while the illustrative embodiment also measures the moving speed of the communication apparatus, it does not include the prior item selecting circuit 107, FIG. 1. The embodiment is also adapted to provide a preferable timing for switching the access channel, which is not shown or described specifically with the embodiment of FIG. 1. It should be noted that the illustrative embodiment also configured to measure the moving speed is assumed to use radio access channels like the embodiment of FIG. 1.

As shown in FIG. 5, the communication apparatus 11 includes an input/output terminal 401, an access channel switching circuit 402, an optimum access channel deciding circuit 403, a speed detecting circuit 404, a channel 1 interface 405, a channel 2 interface 406, and a switching timing deciding circuit 407. The input/output terminal 401, access channel switching circuit 402, speed detecting circuit 404, channel 1 interface 405 and channel 2 interface 406 may be respectively identical in function with the corresponding circuit components 101, 102, 104, 105 and 106 shown in FIG. 1.

The optimum access channel deciding circuit 403 is similar in function to the optimum access channel deciding circuit 103, FIG. 1, except for the following. While the deciding circuit 103 of the previous embodiment cooperates with the prior item selecting circuit 107, the deciding circuit 403 of the illustrative embodiment simply selects the optimum access channel in accordance with speed information S40 output from the speed detecting circuit 404.

User data S42 are input to the switching timing deciding circuit 407. The deciding circuit 407 outputs switching timing control information S45 based on the amount of user data S42 and transfers the information S45 to the access channel switching circuit 402. The switching timing control information S45 selectively allows or inhibits the access channel switching circuit 402 to or from performing the channel switching operation. More specifically, the information S45 allows the switching circuit 402 to switch the access channel in use if the amount of user data S42 is less than a preselected value, or inhibits it from switching the access channel if the amount of user data S42 is equal to or greater than the preselected value.

When the switching timing control information S45. allows the access channel switching circuit 402 to perform the switching operation, the switching circuit 402 switches the access channel in use in accordance with the channel designation information S41 output from the optimum access channel deciding circuit 403. However, the control information S45 inhibits the switching circuit 402 from performing the switching operation, the switching circuit 402 does not switch the access channel even if the channel designation information S41 indicates switching.

By controlling the switching timing as stated above, the illustrative embodiment does not switch the access channel in use when the communication apparatus 11 is about to transmit or receive the greater amount of data. The switching operation requires a data flow having flown up to that time to be stored somewhere. Therefore, if the base station or the channel interface 405 or 406 is not equipped with a buffer having a sufficient capacity, then it is likely that data are lost due to the overflow of the buffer. Even if a buffer with a sufficient capacity is available, a delay occurs before and after the switching operation because an interval between the writing of data in the buffer and the reading of the data out of the buffer constitutes a delay. The amount of data lost or the amount of delay tends to increase with an increase in the amount of data.

As for communication of the kind requiring real-time processing, such as telephone conversation, not only the loss of data but also the delay may deteriorate the communication quality. In this respect, refraining from the switching operation for a moment is rather effective to enhance communication quality.

As stated above, when data are great in amount and therefore likely to suffer from a delay or a loss, the illustrative embodiment limits the access channel switching operation to thereby reduce the degradation of communication quality ascribable to the delay or the loss and stably enhance the communication quality. In addition, the illustrative embodiment achieves the same advantage as the embodiment shown in FIG. 1.

Specific modifications of the embodiments shown and described will be described hereinafter.

In the embodiment shown in FIG. 1, in an application in which the communication apparatus 11 is powered by a battery, then the apparatus 11 may be adapted to determine the amount of power remaining in the battery and produce data representing the amount to transfer the latter in the prior item selecting circuit 107. In such an application, if the remaining power becomes shorter, then priority will be given to the access channel AC1 or AC2 using a communication system of the type consuming a minimum of power. This is successful to save power available with the battery for thereby extending the communicable time.

In the embodiment shown in FIG. 3, the path characteristic detecting circuit 204 estimates path characteristics on the basis of data input via the access channel interfaces 205 and 206. Alternatively, the detecting circuit 204 may be provided with additional input terminals for inputting receive powers on the access channels AC1 and AC2, in which case the detecting circuit 204 will estimate path characteristics on the basis of the receive powers. It may generally be considered that greater power of a given signal is representative of a better path characteristic.

The embodiments shown in FIGS. 1 and 2, 3, and 4 each use one of the moving speed of the communication apparatus 11, the path characteristic of the individual access channel and the traffic on the access channel as an index for selecting the optimum access channel. Of course, such indexes may be replaced with each other or even with a communication charge, communication band or similar conventional index. Further, two or more of such indexes may be used in combination.

The embodiments shown in FIGS. 3, 4 and 5 may, of course, be adapted to additionally include the prior item selecting circuit 107 shown in FIG. 1.

While the embodiment shown in FIG. 5 is a specific extension of the embodiment shown in FIG. 1, such an extension is similarly applicable to the embodiment shown in FIG. 3 or 4 or even to a communication apparatus provided with all of the features of the embodiments shown in FIGS. 1 through 4.

In the embodiment shown in FIG. 5, the switching timing control information S45 is used to reduce the delay or the loss of data. Alternatively, the control information S45 may be used to reduce communication charges by being generated not on the basis of the amount of data, but on the basis of the total amount of data or the total communication time (connection time).

For example, a measured-rate type of charging system that incurs the communication charge stepwise every time a preselected unit chargeable time, e.g. 60 seconds elapses is customary with, e.g. a mobile telephone. In this type of charging system, even when communication is ended well before the unit chargeable time elapses, the communication charge due is the same as when the communication ends just in the unit chargeable period of time. Therefore, the communication charge can be saved if just before elapses a given unit chargeable time assigned to, e.g. the access channel AC1 on which communication is held, the access channel AC1 is replaced with the other access channel AC2.

The charge saving scheme described above can be easily implemented if the communication apparatus 11 is adapted to count a period of time from the start of communication and switch the access channel in such advance before the instant chargeable period of time elapses that a preselected marginal period of time elapses. The marginal period is determined taking into account a period of time necessary for the network 12 to be noticed of the disconnection of the access channel by the communication apparatus 11.

In an application where the network 12 is, e.g. a packet switching network, use is made of a measured-rate type of charging system based on the amount of data, i.e., the amount or number of packets transmitted, instead of the connection period of time. This type of charging system increases the communication charge stepwise every time a preselected amount of data (unit chargeable amount) is sent out. Therefore, it is possible to save the communication charge by measuring the amount of data sent out since the start of communication and then switching the access channel when the unit chargeable amount of data is fully transmitted.

Saving communication charges as stated above is remarkably effective in the embodiments shown and described in which access channel switching is apt to occur frequently because it is automatically executed by the processing of, e.g. the optimum access channel deciding circuit.

Three or more access channel interfaces may be arranged in any one of the embodiments shown and described, as stated earlier.

As for communication of the kind that should be free from even a one-bit error, when required high communication quality will presumably be not attainable with any one of usable access channels, the communication apparatus 11 may wait for the improvement of the environment without selecting any one of the access channels as an optimum access channel.

While the communication apparatus 11 has been shown and described as being a mobile telephone or similar telecommunications terminal, it may be implemented in the form of any other type of telecommunications apparatus. For example, when LANs (Local Area Networks) are interconnected via an ISDN (Integrated Services Digital Network) system, a frame relay network or a network similar to the network 12, the communication apparatus 11 may be implemented as a remote access server or a LAN connecting apparatus. In such a case, the access channels will usually be wired access channels.

While the foregoing description has concentrated on implementation with hardware, the present invention is at least partially practicable with software implementation as well.

In summary, it will be seen that the present invention provides a communication apparatus capable of effecting efficient, high-quality communication by selectively using a plurality of access channels.

The entire disclosure of Japanese patent application No. 2001-325124 filed on Oct. 23, 2001, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A communication apparatus to be connected to a network on one of a plurality of access channels selected, comprising:
an amount detecting circuit for detecting an amount having influence on communication quality held on the access channel selected; and
a selecting circuit for selecting one of the plurality of access channels to be used for communication in accordance with the amount detected by said amount detecting circuit.

2. The communication apparatus in accordance with claim 1, wherein said communication apparatus is a mobile communication apparatus, the amount is a moving speed of said mobile communication apparatus.

3. The communication apparatus in accordance with claim 2, further comprising:
a position detecting circuit for detecting a position of said communication apparatus by using an external measuring system; and
a speed detecting circuit for calculating a moving speed of said communication apparatus in accordance with a change in the position of said communication apparatus.

4. The communication apparatus in accordance with claim 1, wherein the amount is a path characteristic of an individual access channel.

5. The communication apparatus in accordance with claim 4, wherein said communication apparatus switches the access channel in accordance with an error frequency.

6. The communication apparatus in accordance with claim 4, wherein said communication apparatus selects the access channel whose error frequency is lower than a preselected error frequency threshold as an optimum access channel.

7. The communication apparatus in accordance with claim 4, wherein said communication apparatus selects the access channel whose delay is smaller than a preselected delay threshold as an optimum access channel.

8. The communication apparatus in accordance with claim 4, wherein said communication apparatus selects the access channel whose delay fluctuation is smaller than a preselected delay fluctuation threshold as an optimum access channel.

9. The communication apparatus in accordance with claim 1, wherein the amount comprises a receive power on an individual access channel.

10. The communication apparatus in accordance with claim 9, wherein said communication apparatus selects the access channel whose receive power is greater than a preselected receive power threshold as an optimum access channel.

11. The communication apparatus in accordance with claim 1, wherein the amount comprises traffic on an individual access channel.

12. The communication apparatus in accordance with claim 1, wherein when said selecting circuit switches the access channel, a switching timing is selected in accordance with a chargeable unit of a measured-rate type of charging system.

13. The communication apparatus in accordance with claim 1, wherein said selecting circuit switches the access channel at a switching timing when an amount of data being transmitted or received is smaller than a preselected data amount threshold.

14. The communication apparatus in accordance with claim 1, wherein said communication apparatus is powered by a battery, said apparatus further comprising a power detecting circuit configured to detect a power remaining in said battery and limit the access channel to be selected in accordance with the power remaining in said battery.
